(19) United States
(12) Patent Application Publication
(10) Pub. No.: US 2022/0136950 A1
(43) Pub. Date: May 5, 2022

(54) PORTABLE ATMOSPHERIC MONITOR

(71) Applicants: Colorado State University Research Foundation, Frort Collins, CO (US); Access Sensor Technologies LLC, Frort Collins, CO (US)

(72) Inventors: Daniel D. Miller-Lionberg, Denver, CO (US); Casey W. Quinn, Olympia, WA (US); Christian C. L'Orange, Fort Collins, CO (US); Jeffrey R. Pierce, Fort Collins, CO (US); Eric A. Wendt, Fort Collins, CO (US); John Volckens, Fort Collins, CO (US)

(21) Appl. No.: 17/602,147

(22) PCT Filed: Apr. 9, 2020
(86) PCT No.: PCT/US2020/027524

§ 371 Date: Oct. 7, 2021

Related U.S. Application Data
(60) Provisional application No. 62/831,550, filed on Apr. 9, 2019.

(51) Int. Cl. G01N 15/06; G01N 21/53; G01V 8/10

(52) U.S. Cl. CPC G01N 15/06; G01N 2001/2223; G01V 8/10; G01N 21/53

(57) ABSTRACT

In certain embodiments, a portable atmospheric monitor comprises a housing at least partially enclosing an inner chamber. The housing comprises an inlet and an aperture. The monitor also includes at least one light sensor arranged within the housing. The light sensor that senses one or more wavelengths of sunlight received via the aperture. The monitor includes at least one light-scattering sensor that senses PM received via the inlet. The monitor includes a processor arranged within the housing and coupled to the at least one light sensor and the at least one light-scattering sensor. The processor is configured to: receive a light signal from the at least one light sensor; receive a PM signal from the at least one light-scattering sensor; determine the aerosol optical depth based upon the light signal; and determine the PM concentration based upon the PM signal.

### CROSS-REFERENCE TO RELATED APPLICATIONS

This application claims priority to U.S. Provisional Application No. 62/831,550, filed Apr. 9, 2019, entitled “Atmospheric Monitor,” the contents of which is hereby incorporated by reference in its entirety for all purposes.

### STATEMENT REGARDING FEDERALLY SPONSORED RESEARCH OR DEVELOPMENT

This invention was made with government support under grant NNX17AF94A, awarded by NASA Glenn Research Center. The government has certain rights in the invention.

### FIELD

Embodiments of the present disclosure relate to, for example, portable atmospheric monitors. More specifically, certain embodiments of the disclosure are directed to portable atmospheric monitors including co-located components for measuring aerosol optical depth and particular matter (PM), such as PM_{2.5} and/or PM₁₀.

### BACKGROUND

Fine particulate matter air pollution (e.g., PM_{2.5} and/or PM₁₀) is a leading contributor to premature death, disease, and environmental degradation. When inhaled, PM_{2.5} can penetrate deep into the lungs, which can cause long-term and short-term health problems. In 2015, approximately 4.2 million premature deaths were attributed to ambient PM_{2.5} exposure. Embodiments of the present disclosure are directed to a portable air atmospheric monitor configured to accurately measure fine particulate matter.

Satellite-based measurements of aerosol optical depth (AOD) are used to estimate PM_{2.5} concentrations across the world, but the relationship between satellite-estimated AOD and ground-level PM_{2.5} is uncertain.

### SUMMARY

Embodiments of the present disclosure are directed to a portable air atmospheric monitor configured to accurately measure PM and AOD at the same location. Example embodiments include but are not limited to the following examples.

In an Example 1, a portable atmospheric monitor configured to determine an aerosol optical depth and a particulate matter (PM) concentration, the portable atmospheric monitor comprising: a housing at least partially enclosing an inner chamber, the housing comprising an inlet and an aperture; at least one light sensor arranged within the housing, the at least one light sensor configured to sense one or more wavelengths of sunlight received via the aperture; at least one light-scattering sensor arranged within the housing, the at least one light-scattering sensor configured to sense PM received via the inlet; and a processor arranged within the housing and coupled to the at least one light sensor and the at least one light-scattering sensor, the processor configured to: receive at least one light signal from the at least one light sensor; receive at least one PM signal from the at least one light-scattering sensor; determine the aerosol optical depth based upon the at least one light signal; and determine the PM concentration based upon the at least one PM signal.

In an Example 2, the portable atmospheric monitor of Example 1, wherein the light sensor is configured to sense light for four or more wavelength bandwidths.

In an Example 3, the portable atmospheric monitor of Example 2, wherein a width of at least one of the four wavelength bandwidths is less than or equal to 15 nanometers.

In an Example 4, the portable atmospheric monitor of any one of Examples 2-3, wherein the four or more wavelength bandwidths are centered on one or more of the following wavelengths: 340 nanometers (nm), 380 nm, 440 nm, 500 nm, 675 nm, 870 nm, 1020 nm, and 1640 nm.

In an Example 5, the portable atmospheric monitor of any one of Examples 1-4, wherein the at least one light-scattering sensor is configured to sense PM2.5.

In an Example 6, the portable atmospheric monitor of any one of Examples 1-5, wherein the at least one light-scattering sensor comprises more than one light-scattering sensor.

In an Example 7, the portable atmospheric monitor of Example 6, wherein a first light-scattering sensor of the at least one light scattering sensor is configured to sense PM2.5 and a second light-scattering sensor of the at least one light scattering sensor is configured to sense PM10.

In an Example 8, the portable atmospheric monitor of any one of Examples 1-7, wherein the processor is further configured to: identify obstructing objects between the sun and the at least one light sensor; and remove received sensor measurements obtained by the at least one light sensor when the obstructing objects are between the sun and the at least one light sensor.

In an Example 9, the portable atmospheric monitor of Example 8, wherein the processor is configured to identify obstructing objects using machine learning.

In an Example 10, the portable atmospheric monitor of any one of Examples 1-9, wherein the at least one light sensor is a photodiode.

In an Example 11, a method for determining an aerosol optical depth and a particulate matter (PM) concentration using the same device, the method comprising: receiving at least one light signal from at least one light sensor arranged within a housing of a portable atmospheric monitor; receiving at least one PM signal from at least one light-scattering sensor, wherein the at least one light-scattering sensor is arranged within the housing of the portable atmospheric monitor; determining the aerosol optical depth based upon the at least one light signal; and determining the PM concentration based upon the at least one PM signal.

In an Example 12, the method of Example 11, wherein receiving at least one light signal comprises receiving light for four or more wavelength bandwidths.

In an Example 13, the method of Example 12, wherein a width of at least one of the four wavelength bandwidths is less than or equal to 15 nanometers.

In an Example 14, the method of any one of Examples 12-13, wherein the four or more wavelength bandwidths are centered on one or more of the following wavelengths: 340 nanometers (nm), 380 nm, 440 nm, 500 nm, 675 nm, 870 nm, 1020 nm, and 1640 nm.

In an Example 15, the method of any one of Examples 11-14, wherein the at least one PM signal corresponds to PM2.5.

In an Example 16, the method of any one of Examples 11-15, wherein the at least one light-scattering sensor comprises more than one light-scattering sensor.

In an Example 17, the method of Example 16, wherein a first light-scattering sensor of the at least one light scattering sensor senses PM2.5 and a second light-scattering sensor of the at least one light scattering sensor senses PM10.

In an Example 18, the method of any one of Examples 11-17, further comprising: identifying obstructing objects between the sun and the at least one light sensor; and removing received sensor measurements obtained by the at least one light sensor when the obstructing objects are between the sun and the at least one light sensor.

In an Example 19, the method of Example 18, wherein machine learning is used to identify obstructing objects.

In an Example 20, the method of any one of Examples 11-19, wherein the at least one light sensor is a photodiode.

### BRIEF DESCRIPTION OF THE DRAWINGS

FIG. 1 illustrates an exemplary system including a portable atmospheric monitor, in accordance with certain embodiments of the present disclosure;

FIG. 2 illustrates side views of the portable atmospheric monitor shown in FIG. 1;

FIG. 3 illustrates cross-sectional views of an exemplary portable atmospheric monitor, in accordance with certain embodiments of the present disclosure;

FIG. 4A illustrates a front perspective view of another exemplary portable atmospheric monitor, in accordance with certain embodiments of the present disclosure;

FIG. 4B illustrates a front exploded view of the portable atmospheric monitor shown in FIG. 4A;

FIG. 4C illustrates a rear perspective view of the portable atmospheric monitor shown in FIGS. 4A and 4B;

FIG. 5 illustrates a comparison plot between measurements taken by an exemplary portable atmospheric monitor disclosed herein and an Aerosol Robotics Network;

FIG. 6 illustrates a comparison plot between PM_{2.5} measurements taken by an exemplary portable atmospheric monitor disclosed herein and Federal Equivalent Methods; and

FIG. 7 illustrates a binned paired average PM_{2.5} concentration versus paired different AMOD and FEM PM_{2.5} measurements.

While the disclosed subject matter is amenable to various modifications and alternative forms, specific embodiments have been shown by way of example in the drawings and are described in detail below. The intention, however, is not to limit the disclosure to the particular embodiments described. On the contrary, the disclosure is intended to cover all modifications, equivalents, and alternatives falling within the scope of the disclosure as defined by the appended claims.

As the terms are used herein with respect to measurements (e.g., dimensions, characteristics, attributes, components, etc.), and ranges thereof, of tangible things (e.g., products, inventory, etc.) and/or intangible things (e.g., data, electronic representations of currency, accounts, information, portions of things (e.g., percentages, fractions), calculations, data models, dynamic system models, algorithms, parameters, etc.), “about” and “approximately” may be used, interchangeably, to refer to a measurement that includes the stated measurement and that also includes any measurements that are reasonably close to the stated measurement, but that may differ by a reasonably small amount such as will be understood, and readily ascertained, by individuals having ordinary skill in the relevant arts to be attributable to measurement error; differences in measurement and/or manufacturing equipment calibration; human error in reading and/or setting measurements; adjustments made to optimize performance and/or structural parameters in view of other measurements (e.g., measurements associated with other things); particular implementation scenarios; imprecise adjustment and/or manipulation of things, settings, and/or measurements by a person, a computing device, and/or a machine; system tolerances; control loops; machine-learning; foreseeable variations (e.g., statistically insignificant variations, chaotic variations, system and/or model instabilities, etc.); preferences; and/or the like.

Although the term “block” may be used herein to connote different elements illustratively employed, the term should not be interpreted as implying any requirement of, or particular order among or between, various blocks disclosed herein. Similarly, although illustrative methods may be represented by one or more drawings (e.g., flow diagrams, communication flows, etc.), the drawings should not be interpreted as implying any requirement of, or particular order among or between, various steps disclosed herein. However, certain embodiments may require certain steps and/or certain orders between certain steps, as may be explicitly described herein and/or as may be understood from the nature of the steps themselves (e.g., the performance of some steps may depend on the outcome of a previous step). Additionally, a “set,” “subset,” or “group” of items (e.g., inputs, algorithms, data values, etc.) may include one or more items, and, similarly, a subset or subgroup of items may include one or more items. A “plurality” means more than one.

As used herein, the term “based on” is not meant to be restrictive, but rather indicates that a determination, identification, prediction, calculation, and/or the like, is performed by using, at least, the term following “based on” as an input. For example, predicting an outcome based on a particular piece of information may additionally, or alternatively, base the same determination on another piece of information.

The terms “up,” “upper,” and “upward,” and variations thereof, are used throughout this disclosure for the sole purpose of clarity of description and are only intended to refer to a relative direction (i.e., a certain direction that is to be distinguished from another direction), and are not meant to be interpreted to mean an absolute direction. Similarly, the terms “down,” “lower,” and “downward,” and variations thereof, are used throughout this disclosure for the sole purpose of clarity of description and are only intended to refer to a relative direction that is at least approximately opposite a direction referred to by one or more of the terms “up,” “upper,” and “upward,” and variations thereof.

### DETAILED DESCRIPTION

Certain embodiments of the present disclosure relate to the development and validation of the Aerosol Mass and Optical Depth (AMOD) sampler (e.g., AMOD 102 and/or 200), an inexpensive and compact device that simultaneously measures PM_{2.5} mass (and/or PM₁₀) and AOD and may be used in citizen science campaigns. In some examples, the AMOD (e.g., AMOD 102 and/or 200) utilizes a low-cost light-scattering sensor in combination with a gravimetric filter measurement to quantify ground-level PM_{2.5}. In certain embodiments, aerosol optical depth is measured using optically filtered photodiodes at four discrete wavelengths. Field validation studies revealed agreement within 10% for AOD values measured between co-located AMOD (e.g., AMOD 102 and/or 200) and AErosol RObotics NETwork (AERONET) monitors and for PM_{2.5} mass measured between co-located AMOD (e.g., AMOD 102 and/or 200) and EPA Federal Equivalent Method (FEM) monitors. These results demonstrate that the AMOD (e.g., AMOD 102 and/or 200) can quantify AOD and PM_{2.5} accurately at a fraction of the cost of existing reference monitors.

Certain embodiments disclosed herein also describe a portable instrument for the simultaneous measurement of aerosol mass and number concentration, aerosol size distribution, and aerosol optical depth at multiple wavelengths. In some examples, the portable instrument includes a single enclosure for co-located PM and AOD measurement, including a size-selective→inlet, nephelometer→filter and mass flow sensor, and an AOD turret. In some embodiments, using a digital image captured in real-time and pointed toward the Sun, an adaptive algorithm (e.g., a machine learning algorithm) performs active cloud screening by identifying the presence (or absence) of sky features (such as clouds) that would affect the quality of the radiometer data. This could be done in many ways, including with solar power, autonomous function and data transfer, self-calibrating and self-cleaning functions, and gas sensors.

### 1 Introduction

Recently, satellite observations have been used to estimate PM_{2.5} levels at the Earth's surface. These estimates have facilitated global estimates air pollution's impact on public health, especially in remote and resource-limited environments. Satellite-based observations provide an estimate of aerosol optical depth (AOD), a dimensionless measure of light extinction in the atmospheric column. Satellite-derived AOD retrievals are then used to estimate PM_{2.5} concentrations at the Earth's surface. The relationships between AOD and PM_{2.5} concentration, has been expressed as follows, which is also known as the Beer-Lambert-Bouger law:

PM_{2.5}=η·AOD (1)

where η is a conversion factor between PM_{2.5} and AOD. If η is known, satellite AOD estimates can be directly converted to surface PM_{2.5} concentrations. However, this conversion factor is sensitive to aerosol properties, aerosol composition, surface reflectivity, and vertical profile, all of which can vary across time and space. Thus, satellite estimates of AOD are prone to error.

To improve satellite AOD retrievals, sun photometers may be used to measure AOD from the Earth's surface. Sun photometers use photodetectors to measure the incident flux of photons at a given wavelength of light. In conjunction with the Beer-Lambert-Bouger law, aerosol optical depth (τₐ) may be calculated from a Sun photometer measurement per the following equation:

τₐ(λ)=1/m(ln(Vₒ/R²)−ln(V))−τ_{R}(λ,p)−τₒ₃ (2)

where, m is the relative optical air mass factor, which accounts for different path lengths through the atmosphere when the sun is at different angles, R is the Earth-sun distance in astronomical units (AU), V is the voltage read by the light detector, τ_{R} accounts for Rayleigh scattering by air molecules, p is the pressure, λ is the wavelength, τₒ₃ accounts for ozone absorption, and the extraterrestrial constant, Vₒ, is the voltage produced by incident light at the top of the atmosphere. Vₒ is evaluated via calibration. In some examples, the primary method to find V₀ is the Langley plot method. By combining the aerosol, ozone absorption, and Rayleigh components into total optical depth (τ) and rearranging Eq. (2), the following equation (used for a Langley plot) is derived:

ln(V)=ln(Vₒ/R²)−τ·m (3)

During a Langley calibration, voltage measurements are taken as the air mass factor changes over the course of a day. The slope of the line gives total optical depth and the intercept at m=0 gives the constant V₀. According to certain embodiments, secondary extraterrestrial constant calibrations are performed relative to units calibrated via the Langley plot method. In some examples, relative calibrations are performed by taking coincident measurements with a calibrated and an uncalibrated unit and solving Eq. (2) for V₀, with V equal to the light detector voltage from the uncalibrated unit, τₐ equal to the AOD reported by the calibrated unit, and all other parameters equal to those reported by the uncalibrated unit.

In certain embodiments, when AOD is measured at multiple wavelengths, and the Angstrom exponent, α, is known, AOD for non-measured wavelengths may be inferred from the following relation:

τₐ(λ)=τₐ₀·(λ₀)·(λ/λ₀)^{-α} (4)

where λ₀ is a wavelength measured by the photometer, λ is the new wavelength and τₐ₀ is the measured AOD from the photometer. In some examples, the Ångström exponent varies depending on the aerosol size distribution; a tends to decrease with increasing particle size and may not be constant across all wavelength pairs. In some embodiments, when AOD is measured at multiple wavelengths, curvature in α can be calculated, providing more insight into the aerosol properties.

According to certain embodiments, equation (2) assumes that the photometer measures the intensity of monochromatic incident light. Because the sun is a polychromatic emitter, sun photometers feature light detectors of narrow spectral bandwidth. Light detectors with full-width half-maximum (FWHM) spectral bandwidths of 15 nm or narrower can be approximated as monochromatic. In some examples, this requirement precludes the use of inexpensive photodiodes as light detectors because of their wide spectral bandpass (30>nm). The CE318 (Cimel Electronique SAS, Paris, France) used in the Aerosol Robotics Network (AERONET), include photodiodes fitted with optical interference filters to achieve monochromatic detection. However, high-quality bandpass filters can be cost prohibitive. High cost (e.g., >$50,000) and maintenance requirements have disqualified the use of expensive interference filter sun photometers in large-scale validation studies and in locations where adequate capital and line power are lacking.

In certain embodiments, PM_{2.5} samplers co-located with sun photometers can help inform the relationship between AOD and surface PM_{2.5} concentration. The U.S. Environmental Protection Agency, which regulates ambient concentrations of PM_{2.5} mass, has designated a list of Federal Reference Methods (FRMs) and Federal Equivalent Methods (FEMs) that are used to monitor PM_{2.5} (US EPA, 2017) according to a set of design and performance characteristics. Like reference-grade sun photometers, the deployment prospects of FRM and FEM monitors are limited by their cost ($10,000-$30,000) and the need for line power.

This disclosure develops a user-friendly and low-cost (relative to reference methods) aerosol sampler capable of accurate and precise AOD and PM_{2.5} measurements to be used in citizen science campaigns. The embodiments combine filtered photodiode-based AOD measurements, time-resolved PM_{2.5} measurement via light-scattering, and a time-integrated, gravimetric PM_{2.5} mass measurement to accomplish this objective. The resultant device, the Aerosol Mass and Optical Depth (AMOD) sampler (e.g., AMOD 102 and/or 200), is capable of simultaneous sun photometry and mass-based particulate matter measurements. In this disclosure, the embodiments describe the design of the AMOD (e.g., AMOD 102 and/or 200) and its validation against reference monitors in real-world environments.

### 2 Materials and Methods

### 2.1 Instrument Design

The original, wearable UPAS housing was designed to measure personal exposure to aerosols in indoor and work environments. Later, UPAS technology was integrated into a weatherproof housing for outdoor deployments to sample wildland fire smoke. The scientific goals of the AMOD (e.g., AMOD 102 and/or 200) development dictated the UPAS be modified for outdoor and primarily stationary measurement of both PM_{2.5} and AOD. Notable modifications included: a) additional hardware to support AOD measurement capability; b) firmware updates for simultaneous PM_{2.5} and AOD sampling; c) inclusion of a low-cost light-scattering sensor for real-time PM₂₅ measurement; d) a larger battery and a solar panel for extended battery life; and e) a new weather-resistant housing. According to certain embodiments, PM₁₀ may also be monitored and/or obstructions may identified and the results corrected for when obstructions are identified. In some embodiments, obstructions may be identified using machine learning.

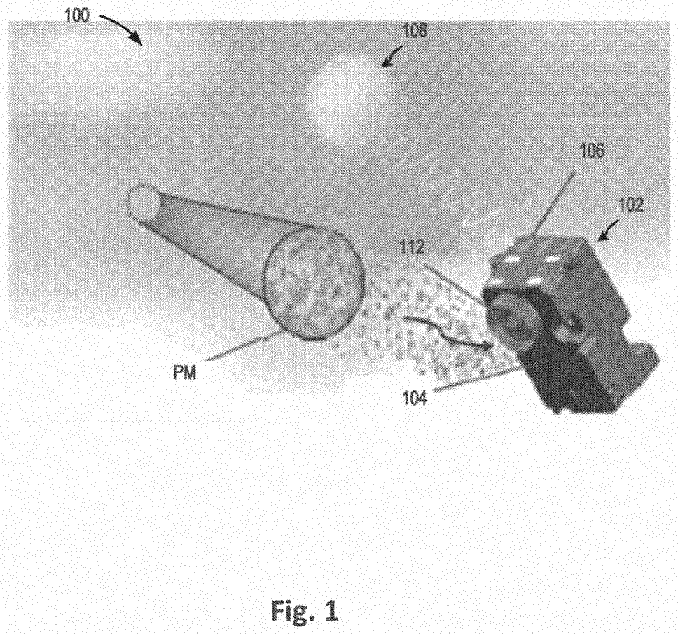

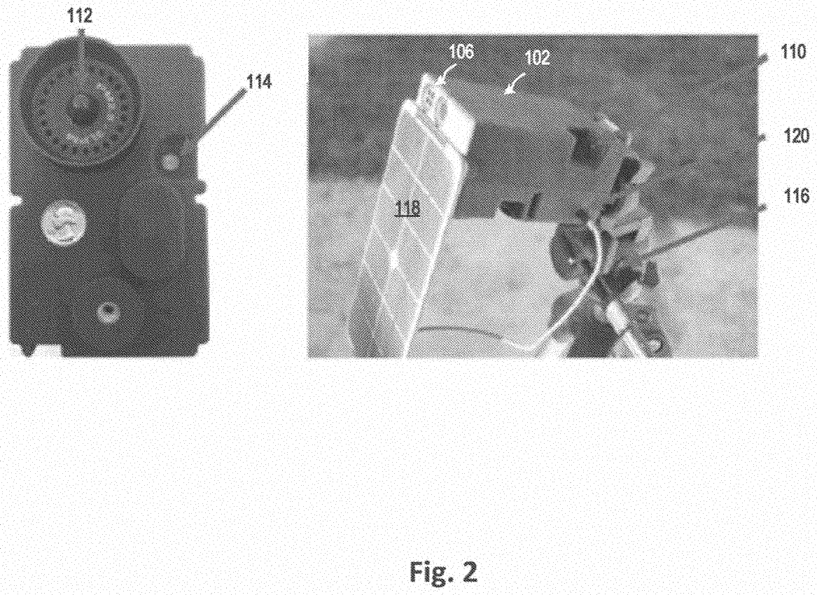

FIG. 1 illustrates an exemplary system 100 including a portable atmospheric monitor 102 and FIG. 2 illustrates side views of the portable atmospheric monitor 102. According to certain embodiments, the portable atmospheric monitor 102 is referred to herein as AMOD and/or AMOD sampler.

As shown, the portable atmospheric monitor 102 includes a housing 104. In some examples, the housing 104 includes one or more apertures 106 configured to receive sunlight from the sun 108 and project the sunlight on to a sunspot target 110, as shown in FIG. 2.

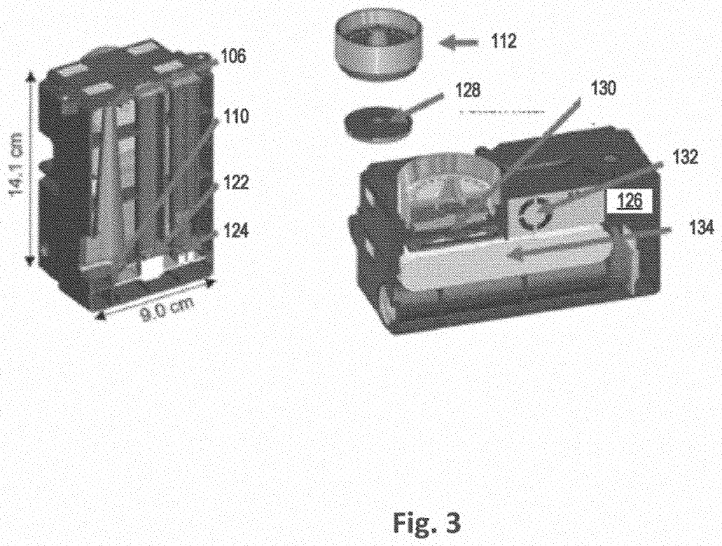

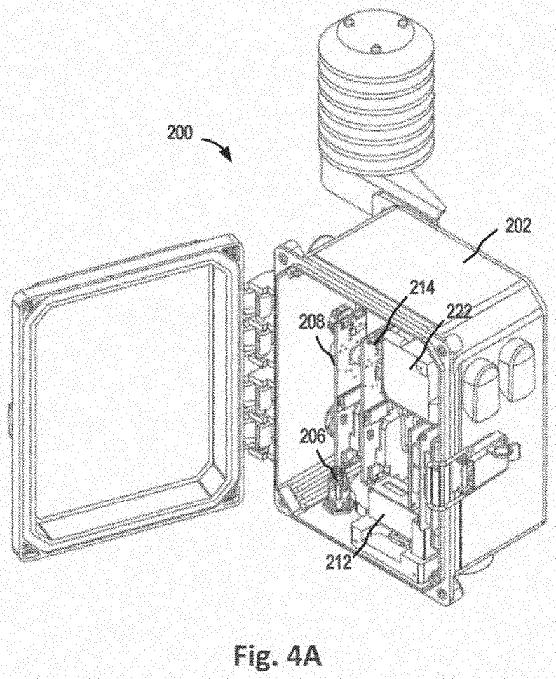

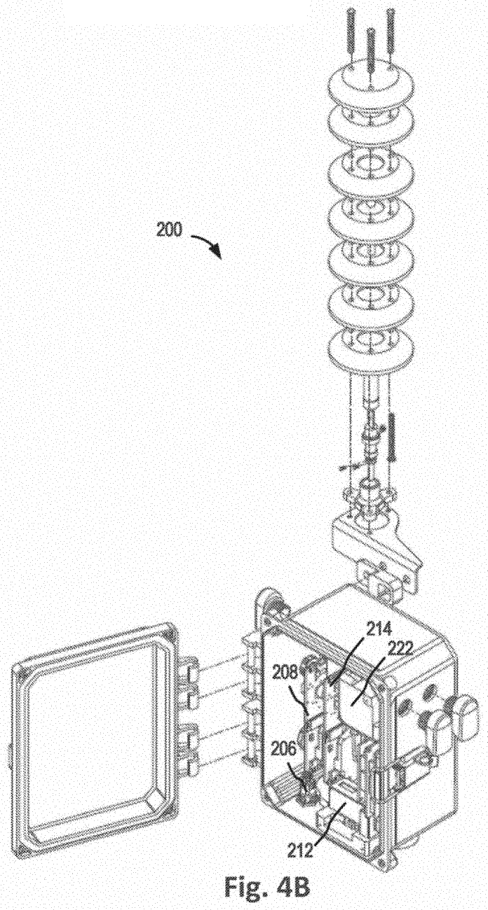

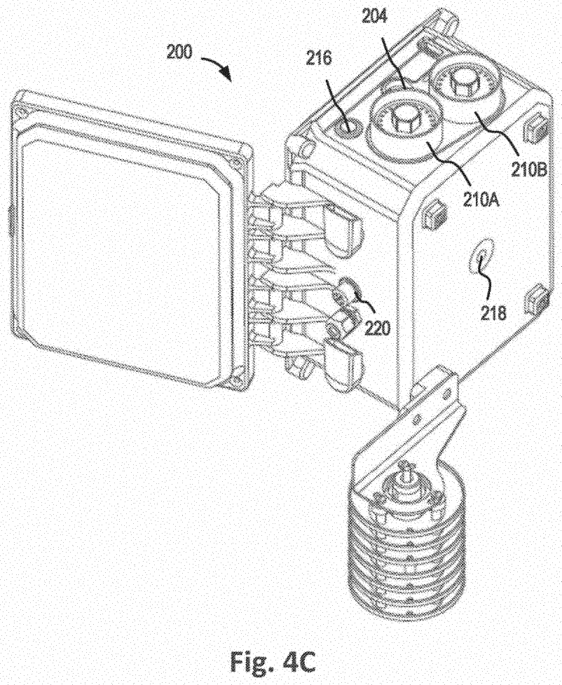

In certain embodiments, the housing 104 also includes one or more inlets 112 configured to receive PM. In some examples, the inlet 112 can be a PM_{2.5} cyclone inlet 112. According to certain embodiments, the PM can be filtered via one or more filters (e.g., the filter 128 illustrated in FIG. 3). In some embodiments, the one or more filters are configured to filter certain types of PM so that only a certain type of PM passes through the filter, such as PM_{2.5} or PM₁₀. In some examples, the housing 104 comprises more than one inlet 112 and more than one filter in order to filter different types of PM, as shown in FIGS. 4A-4C. Additional details about the inlet 112 are disclosed in U.S. patent application Ser. No. 16/653,546, entitled “Portable Air Sampling Device” and filed on Oct. 15, 2019, the entire contents of which are incorporated herein by reference for all purposes.

In certain embodiments, the portable atmospheric monitor 102 includes an on/off button 114 arranged on an exterior of the portable atmospheric monitor 102 for turning the portable atmospheric monitor 102 on and off.

In certain embodiments, the portable atmospheric monitor 102 can be secured to a stand (e.g., a tripod mount) 116, as shown in FIG. 2. In some examples, the portable atmospheric monitor 102 can be moved manually or automatically to orient a surface of the one or more apertures 106 normal to rays of light from the sun 108. In some examples, a solar alignment sensor (e.g., the solar alignment sensor 122 illustrated in FIG. 3) can be used to orient the portable atmospheric monitor 102.

In certain embodiments, the portable atmospheric monitor 102 can be charged via a solar panel 118 that is coupled to a charging port 120 of the portable atmospheric monitor 102.

According to certain embodiments, the housing 104 encloses one or more components, as shown in FIG. 3.

FIG. 3 illustrates cross-sectional views of an exemplary portable atmospheric monitor 102, in accordance with certain embodiments of the present disclosure.

As shown, the portable atmospheric monitor 102 includes one or more aerosol optical depth (AOD) sensors 124 according to certain embodiments. In some examples, the one or more AOD sensors 124 are configured to receive light projected on to the sunspot target 110 and convert the light to one or more light signals (e.g., voltages). In some embodiments, the light signals can then be converted to an aerosol optical depth by a microprocessor, e.g., the microprocessor 126.

According to certain embodiments, the PM received through the inlet 112 is filtered by a filter 128. As stated above, in some examples, the filter 128 is configured to filter certain types of PM so that only a certain type of PM passes through the filter, such as PM2.5 and/or PM10. To facilitate PM being received through the inlet 112, the portable atmospheric monitor 102 includes an internal ultrasonic pumping system 130 in at least some embodiments. According to certain embodiments, PM that passes through the filter 128 may be received by a light-scattering PM sensor 132 that converts the PM into one or more PM signals. In some embodiments, the PM signals can then be converted to a PM concentration by a microprocessor, e.g., the microprocessor 126.

According to certain embodiments, the portable atmospheric monitor 102 may be powered by power source 134, such as a lithium ion battery. In some examples, the power source 134 may be charged via a solar panel 118 and a charging port 120.

FIG. 4A-4C illustrate another exemplary portable atmospheric monitor 200, in accordance with certain embodiments of the present disclosure. According to certain embodiments, the portable atmospheric monitor 200 can have the same or similar features as the portable atmospheric monitor 102. According to certain embodiments, the portable atmospheric monitor 102 is referred to herein as AMOD and/or AMOD sampler.

As illustrated, the portable atmospheric monitor 200 includes a housing 202. In some examples, the housing 202 includes one or more apertures 204 configured to receive sunlight from the sun (e.g., the sun 108) and project the sunlight on to a sunspot target. In some examples, the portable atmospheric monitor 200 includes one or more aerosol optical depth (AOD) sensors 206 that are configured to receive light projected on to the sunspot target and convert the light to one or more light signals (e.g., voltages). In some embodiments, the light signals can then be converted to an aerosol optical depth by a microprocessor, e.g., the microprocessor 208.

In certain embodiments, the housing 202 also includes more than one inlet 210A, 210B configured to receive PM. In some examples, the inlet 210A can be a PM_{2.5} cyclone inlet and the inlet 210B can be a PM₁₀ cyclone inlet. According to certain embodiments, the PM can be filtered via one or more filters. In some embodiments, the one or more filters are configured to filter certain types of PM so that only a certain type of PM passes through the filter, such as passing through PM_{2.5} or PM₁₀. To facilitate PM being received through the inlets 210A, 210B, the portable atmospheric monitor 200 includes an internal ultrasonic pumping system in at least some embodiments. According to certain embodiments, PM that passes through the filter may be received by a light-scattering PM sensor 212 that converts the PM into one or more PM signals. In some embodiments, the PM signals can then be converted to a PM concentration by a microprocessor, e.g., the microprocessor 214.

Additional details about exemplary inlets that can be used as the inlets 210A, 210B are disclosed in U.S. patent application Ser. No. 16/653,546, entitled “Portable Air Sampling Device” and filed on Oct. 15, 2019, the entire contents of which are incorporated herein by reference for all purposes.

In certain embodiments, the portable atmospheric monitor 200 includes an on/off button 216 arranged on an exterior of the portable atmospheric monitor 200 for turning the portable atmospheric monitor 200 on and off.

In certain embodiments, the portable atmospheric monitor 200 can be secured to a stand (e.g., stand 116) via a coupling mechanism 218 (e.g., a socket). In some examples, the portable atmospheric monitor 200 can be moved manually or automatically to orient a surface of the one or more apertures 204 normal to rays of light from the sun. In some examples, a solar alignment sensor can be used to orient the portable atmospheric monitor 200.

In certain embodiments, the portable atmospheric monitor 200 can be charged via a solar panel (e.g., solar panel 118) that is coupled to a charging port (e.g., charging port 220) of the portable atmospheric monitor 220.

According to certain embodiments, the portable atmospheric monitor 102 may be powered by power source 222, such as a lithium ion battery. In some examples, the power source 222 may be charged via a solar panel and a charging port 222.

According to certain embodiments, candidate sensors for the sensors 124, 206 include filtered photodiodes (e.g., Intor Inc., Socorro, N. Mex., USA), light emitting diodes (e.g., LEDs; Lighthouse LED AFSMUBC12, WA, USA), and vertical cavity surface emitting lasers (e.g., VCSELs; Vixar Inc. I0-0680M-0000-KPO1, Plymouth, Minn., USA)—the latter two operated as detectors. These sensor options were evaluated according to cost, variety of available center wavelengths, and spectral bandpass measured at full-width half maximum (FWHM). Spectral bandpass measurements were made using a tunable light source (e.g., Optometrics TLS-25M, Littleton, Mass., USA) for LED detectors and a tunable dye laser (e.g., Sirah Lasertechnik Allegro, Grevenbroich, Germany) for filtered photodiode and VCSEL detectors. According to certain embodiments, filtered photodiodes were selected for use in the AMOD (e.g., AMOD 102 and/or 200) due to their sufficiently narrow spectral response bandwidth (<15 nm) and relatively low cost. Filtered photodiodes were also commercially available at center wavelengths from 400 nm to 1000 nm in increments of approximately 10 nm. In some examples, no other detector option offered as broad of a selection. LEDs were the least expensive option but were not selected due to their broad spectral response bandwidth. VCSELs were cost prohibitive and exhibited multiple undesirable response peaks.

According to certain embodiments, a printed circuit board (including, for example, the processor 126 and/or 208) containing AOD measurement instrumentation was designed using Autodesk® EAGLE. When populated, this board contained four or more filtered photodiodes, a quad (or greater) operational amplifier with low leakage current (e.g., Linear Technology LTC 6242, Milpitas, Calif., USA) and a 16-bit analog-to-digital converter (e.g., Texas Instruments ADS1115, Dallas, Tex., USA) according to certain embodiments. In some examples, photodiode wavelengths of 340 nm, 380 nm, 440 nm, 500 nm, 675 nm, 870 nm, 1020 nm, and/or 1640 nm were selected to avoid molecular absorption bands, to match wavelengths used by AERONET, and to facilitate aerosol size evaluation. In some examples, the board includes a solar incidence sensor (e.g., Solar MEMS NANO-ISS5, Seville, Spain) and a Wi-Fi module (e.g., Espressif Systems ESP8266, Shanghai, China or ESP32) and/or Bluetooth module (e.g., RN4677 Bluetooth Module). A GPS (e.g., u-blox CAM-M8, Thalwil, Switzerland) provides location data (longitude, latitude, and altitude) calculated the position of the Sun and estimate ozone optical depth according to certain embodiments. The AOD measurement board (including, for example, the processor 126 and/or 208) was interfaced with the primary UPAS motherboard via I2C and UART communication. Sampler control firmware was written in C++ on the Mbed™ platform (ARM® R Ltd., Cambridge, UK).

According to certain embodiments, a light-scattering particulate-matter sensor (e.g., the sensor 132 and/or 212) (e.g., Plantower PMS5003, Beijing, China) was integrated into the sampler housing. The PMS5003 included a fan (e.g., the umping system 130) that pulled aerosol through the path of a laser diode and a photodetector. PM concentrations were evaluated by a microprocessor (e.g., processor 126) embedded in the PMS5003 and accessed via serial communication.

According to certain embodiments, the AMOD housing (e.g., the housing 104 and/or 202) was designed using SolidWorks® (e.g., ANSYS, Inc., Canonsburg, Pa., USA) and built using stereolithographic printing. In some examples, the housing (e.g., the housing 104 and/or 202) included four tubes that limited the field of view of the light detectors. Light entered through 5 mm diameter apertures (e.g., apertures 106 and/or 204) on the top surface of the housing (e.g., the housing 104 and/or 202) and subsequently passed through 112 mm long tubes to the active area of the filtered photodiodes. These dimensions yielded an angle of view of 2.56 degrees per sensor, approximately five times the angular diameter of the sun, but within aperture ranges reported for other low-cost sun photometers. In some examples, a narrow viewing angle is required to mitigate errors caused by forward scattered sunlight entering the field of view of the detector. In some examples, the housing (e.g., the housing 104 and/or 202) also included a sealed inlet and outlet for flow through the PMS5003 sensor. Two sockets with ¼-20 Unified National Coarse threads allowed the AMOD (e.g., AMOD 102 and/or 200) to be mounted to standard camera tripods. According to certain embodiments, the housing was weather-resistant when mounted in its intended orientation—with the PM_{2.5} inlet facing the ground and the AOD apertures pointed toward the sun (FIG. 2). IN some examples, an O-ring seal prevented leakage through the seam of the housing halves and float-glass windows sealed with foam adhesive protected the optical apertures.

In certain embodiments, the internal AMOD (e.g., AMOD 102 and/or 200) battery (e.g., the power source 134 and/or 222) is a 3.6 V, 20.1 Ah custom battery pack comprising six 18650 lithium ion cells (e.g., Panasonic NCR18650B, Kadoma, Japan). In some examples, the battery was charged via a barrel plug port (e.g., port 120 and/or 220) on the side of the housing. This plug accepted power from a wall charger, external battery, or solar panel (e.g., Voltaic® 3.5 W) and was watertight when the solar panel cable was attached to the barrel port. In some examples, the removable solar panel (e.g., the solar panel 118) was mounted to the exterior housing using magnets adhered to opposing surfaces on the panel and AMOD housing.

In certain embodiments, the dimensions of the AMOD (e.g., AMOD 102 and/or 200) were 9.0 cm W×14.1 cm H×6.7 cm L and the weight was 0.64 kg. In some examples, the total cost of goods of the AMOD (e.g., AMOD 102 and/or 200) was less than $1,100. According to certain embodiments, this tabulation was based on a production run of 24 units. In some examples, the average assembly time for a single AMOD (e.g., AMOD 102 and/or 200) was estimated at two hours, which translated to a cost of $50 at a rate of $25 per hour.

### 2.2 Calibration Procedure

According to certain embodiments, one AMOD (e.g., AMOD 102 and/or 200) master unit (e.g., the portable atmospheric monitor 102 and/or portable atmospheric monitor 200) was calibrated relative to a Cimel CE318 at the DigitalGlobe AERONET site in Longmont, Colo. AERONET instruments are calibrated using the Langley plot technique at Mauna Loa observatory—or relative to other AERONET instruments that have been so calibrated—to AOD uncertainties between 0.002 and 0.005. In some examples, the master AMOD (e.g., AMOD 102 and/or 200) calibration consisted of co-located and concurrent measurements taken over the course of two to four hours. The extraterrestrial constant (V₀) was determined for each individual measurement by solving Eq. (2) using the AERONET value for AOD. In some examples, the extraterrestrial constant for the master AMOD (e.g., AMOD 102 and/or 200) unit was then determined by averaging the extraterrestrial constant calculated from each individual measurement. The extraterrestrial constants of all other AMOD (e.g., AMOD 102 and/or 200) units were derived relative to the AMOD (e.g., AMOD 102 and/or 200) master unit by taking a series of simultaneous measurements under variable illumination according to certain embodiments. The extraterrestrial constant for all other units, V_{0,i}, was determined as follows:

V_{0,i}=V_{0,master}·ρᵢ (5)

where V_{0,master} is the extraterrestrial constant of the master unit and ρᵢ is the average ratio of photodiode voltage readings from uncalibrated unit i to the master unit.

### 2.3 AOD Calculation Algorithm

According to certain embodiments, the AOD calculation firmware may be determined using an online, open-source platform (e.g., Mbed™; ARM® Ltd., Cambridge, UK), which was executed by the on-board microcontroller (e.g., STMicroelectronics STM32L152RE, Geneva, Switzerland). In some examples, prior to applying Eq. (2) to calculate AOD, the Earth-Sun distance (R), the relative optical air mass factor (m), and the Rayleigh optical depth (τ_{R}) were determined in accordance with the measurement location, time, pressure, and temperature. The National Renewable Energy Laboratory (NREL) published a solar position algorithm to calculate azimuth, elevation and zenith angles at uncertainties equal to +/−0.0003 as a function of location, time and for years between 2000 and 6000. In some examples, this algorithm is implemented as a C++ microcontroller code to automate solar calculations for the AMOD (e.g., AMOD 102 and/or 200). In some examples, the Earth-Sun distance was calculated directly by the solar position algorithm.

The relative optical air mass factor was calculated in terms of the solar zenith angle, θ, as follows:

$$m = \frac{( 1.002 \; 432 \cdot {cos}^{⩓} 2 ( θ ) + 0. 1 \; 48386 \cdot cos ( θ ) + 0.009 \; 6467 )}{\begin{matrix}( {cos}^{⩓} 3 ( θ ) + 0.149864 \cdot {cos}^{⩓} 2 ( θ ) + \\ 0.0102963 \cdot cos ( θ ) + 0. 000303978 )\end{matrix}} \qquad ( 6 )$$

According to certain embodiments, the contributions of Rayleigh scattering and ozone absorption to total optical depth are often substantial and must be subtracted from the total optical depth for accurate AOD measurements. Rayleigh optical depth is inversely proportional to the fourth power of wavelength, which made accurate quantification especially important for the 440 nm and 520 nm channels on the AMOD (e.g., AMOD 102 and/or 200). In some examples, Rayleigh optical depth was calculated based on wavelength and ambient pressure measured by an on-board pressure sensor (e.g., Bosch Sensortec BMP 280, Kusterdingen, Germany). In some examples, the AMOD's 520 nm and 680 nm channels were within the Chappuis ozone absorption band (450 nm-850 nm). According to certain embodiments, an empirical model is to estimate ozone concentrations in Dobson Units (DU)—based on the location and time of the measurement-which were then used to determine the ozone optical depth.

Finally, Eq. (2) was applied to determine the total optical depth using sensor inputs; the extraterrestrial constant; and the calculated Earth-Sun distance, relative optical air mass factor, Rayleigh optical depth, and ozone absorption optical depth according to certain embodiments. In some examples, AOD, temperature, pressure, relative humidity, time, location, and battery status were then stored on an accessible MicroSD card (e.g., Molex 5031821852, Lisle, Ill., USA).

### 2.4 User Operation and Measurement Procedure

According to certain embodiments, the AMOD (e.g., AMOD 102 and/or 200) is designed to be operated by individuals without a background in aerosol sampling but with an interest in air pollution and citizen science. Care was taken to minimize the complexity of the measurement process. In some examples, a smartphone application guides user through a single measurement in a series of steps. In some examples, items needed to complete a measurement included an AMOD (e.g., AMOD 102 and/or 200) unit, a filter cartridge loaded with a pre-weighed air-sampling filter, a smartphone (iOS or Android enabled) with the device application (e.g., “CEAMS”; available on the Apple App Store and Google Play) downloaded, and a commercial tripod or alternative mount. Prior to initiating a measurement, the operator manually loaded the filter cartridge into position and aligned the AOD sensors with the sun. According to certain embodiments, the alignment process was aided by an integrated pinhole and target apparatus, which was geometrically aligned with the filtered photodiodes (FIGS. 1 and 2). Once the AMOD (e.g., AMOD 102 and/or 200) was aligned, the operator initiated a sample with the smartphone application according to certain embodiments. In some examples, the AMOD (e.g., AMOD 102 and/or 200) then recorded an instantaneous AOD measurement and began sampling air onto the filter under active control of mass flow at 2 L min-1. In certain examples, the AMOD (e.g., AMOD 102 and/or 200) also began recording real-time PM_{2.5} levels reported by the PMS5003. In certain embodiments, air sampling continued for 48.25 hours before the AMOD (e.g., AMOD 102 and/or 200) automatically shut off. The AMOD (e.g., AMOD 102 and/or 200) maintained a fixed orientation on a tripod for the entire sampling duration-barring any unintended movements according to certain embodiments. In some examples, the AMOD (e.g., AMOD 102 and/or 200) sampled AOD three times over the 48.25-hr sampling period: immediately after the sample started, 24 hours into the sample, and 48 hours into the sample (i.e., at each solar overpass). To partially mitigate errors caused by day-to-day changes in the Sun's position, the AMOD (e.g., AMOD 102 and/or 200) began measuring AOD 15 minutes prior to the 24-hour mark and logged AOD values every 30 seconds until 15 minutes after the 24-hour mark according to certain embodiments. In some examples, the operator is able to use this 30-minute window to correct the AMOD's (e.g., AMOD 102 and/or 200) orientation if unintended movements had taken place since the start of the sample. In some examples, the lowest AOD values-which corresponded with the highest photodiode signal—from the 30-minute measurement window at 24-hours and 48-hours are taken as the second and third AOD measurements. Upon completion of the sample, the operator downloaded data from the AMOD (e.g., AMOD 102 and/or 200) using the smartphone application and transferred the data to a host server according to certain embodiments.

### 2.5 Co-location Validation Studies

In certain embodiments, AMOD (e.g., AMOD 102 and/or 200) AOD measurements were validated in a series of co-location studies using AERONET monitors as the reference method. AERONET monitors were available at two sites along the Colorado Front Range: NEON-CVALLA (N 40° 09′39″, W 105° 10′01″) and Digital Globe (N 40° 08′20″, W 105° 08′13″). Co-location tests took place on three separate days using seven different AMOD (e.g., AMOD 102 and/or 200) units. In some examples, between two and four calibrated AMOD (e.g., AMOD 102 and/or 200) units were randomly selected on each testing day and deployed within 50 m of the AERONET monitor. In some examples, a total of seven AMOD (e.g., AMOD 102 and/or 200) instruments were used in co-location studies. Four-wavelength AMOD (e.g., AMOD 102 and/or 200) AOD measurements were taken at five-minute intervals over the course of one to four hours on each measurement day according to certain embodiments. In some examples, AMOD (e.g., AMOD 102 and/or 200) data were then compared with Level 1.0 AOD data published in the online AERONET database. In some examples, AMOD (e.g., AMOD 102 and/or 200) measurements concurrent within 2 minutes of an AERONET measurement were included in the comparison data set for the wavelength in question. The 500 nm and 675 nm AOD values from the AERONET instruments were adjusted-using Eq. (4) and Angstrom coefficients from the AERONET data set—to match the 520 nm and 680 nm channels on the AMOD (e.g., AMOD 102 and/or 200), respectively, according to certain embodiments. In some examples, the 440 nm and 870 nm channels required no adjustment because the AMOD (e.g., AMOD 102 and/or 200) and the AERONET monitors both measure at those wavelengths.

According to certain embodiments, time-integrated PM_{2.5} mass concentrations measured using the AMOD (e.g., AMOD 102 and/or 200) filter samples were validated in a series of 48-hr co-location tests conducted with FEM monitors. AMOD (e.g., AMOD 102 and/or 200) units were loaded with 37 mm PTFE filters (e.g., MTL PT37P-PF03, Minneapolis, Minn. USA). In some examples, the FEM consisted of an EPA-certified Louvered Inlet (PM10—Mesa Labs SSI2.5, Lakewood, CO USA) with an inline PM_{2.5} cyclone (e.g., URG Corp 2161, Chapel Hill, N.C. USA) operating at 16.7 L/min. The PM_{2.5} sample was collected on a 47 mm PTFE filter (e.g., Tisch Scientific SF18040, North Bend, Ohio USA). In some examples, airflow through the inlet, cyclone, and filter cartridge was maintained by a pump (Gast 86R142-P001B-N270X, Benton Harbor, Mich. USA) and metered using a massflow controller (e.g., Alicat MCRW-20SLPM-Di5M, Tucson, Ariz. USA). Co-location tests occurred in multiple locations—including downtown Fort Collins, the Colorado State University main campus, and at several personal residences across the city-over a 10-week period according to certain embodiments. In some examples, a custom mount was constructed to support the FEM monitors and hold AMOD (e.g., AMOD 102 and/or 200) samplers at 40 cm from the FEM inlet.

According to certain embodiments, the PM_{2.5} mass concentrations measured using the PMS5003 included in the AMOD (e.g., AMOD 102 and/or 200) were evaluated against a collocated light-scattering FEM monitor (e.g., EDM 180, GRIMM, Ainring, Germany) at the Colorado State University main campus (EPA monitoring site 08-069-0009). In some examples, light-scattering readings from the AMOD (e.g., AMOD 102 and/or 200) PMS5003 were corrected post hoc, relative to the AMOD (e.g., AMOD 102 and/or 200) filter, by multiplying each light-scattering reading by a scaling factor equal to the ratio of the filter measurement to the 48-hr average of the PMS5003. Hourly averages of the corrected readings were then calculated for comparison to the hourly concentrations reported by the GRIMM EDM 180 according to certain embodiments.

### 3 Results and Discussion

### 3.1 AOD Sensor Evaluation

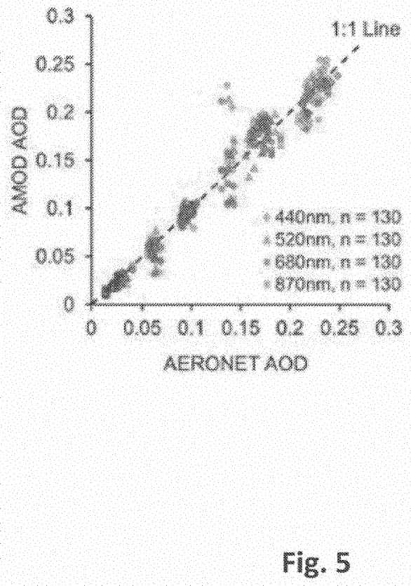

Close agreement was observed between the AMOD (e.g., AMOD 102 and/or 200) and AERONET monitors for AOD. A comparison plot for all wavelengths and all AERONET co-location testing data is provided in FIG. 5 (n=130 paired measurements for each wavelength). The mean absolute error between the AMOD (e.g., AMOD 102 and/or 200) and AERONET instruments was 0.0079 AOD units (across all wavelengths), yielding a mean relative error of 10%. These deviations were nearly within the published uncertainties of the AERONET monitors (0.002-0.005). The mean AOD difference was 0.00063 with 95% confidence upper and lower limits of agreement of 0.026 and −0.024, respectively. The mean difference results indicated a low systematic bias between the two instruments in AOD units. The single set of outlier points shown in FIG. 5 was most indicative of a misalignment error because: 1) the error relative to AERONET was at least 3× the error of all other measurements from the same AMOD (e.g., AMOD 102 and/or 200) unit; 2) measurements taken at the same time and location with different AMOD (e.g., AMOD 102 and/or 200) units exhibited lower error; and 3) the AOD was over-predicted by the AMOD (e.g., AMOD 102 and/or 200), which is consistent with lower photodiode signal from misalignment. Agreement between AMOD (e.g., AMOD 102 and/or 200) units was comparable to the agreement between AMOD (e.g., AMOD 102 and/or 200) units and AERONET monitors. The average coefficient of variation between AMOD (e.g., AMOD 102 and/or 200) measurements, expressed as a percentage, was 9.0%.

The embodiments measured relatively low AOD values due to the low aerosol concentrations at regional AERONET stations in fall 2017. In some examples, this limitation is not viewed as consequential because the linear dynamic range of the photodetectors used in the AMOD (e.g., AMOD 102 and/or 200) includes AOD values from 0-5 AOD units (specific voltages associated with AOD values are wavelength and calibration dependent). In some examples, thin cirrus cloud cover on some days likely yielded the highest AOD values; while this was not strictly “aerosol” optical depth, it allowed for validation across a greater AOD range against the non-cloud-filtered Level 1.0 AERONET data.

Compared with AERONET monitors, the main advantages of the AMOD (e.g., AMOD 102 and/or 200) are its low cost and portability. The AMOD (e.g., AMOD 102 and/or 200) (including light-scattering and integrated PM_{2.5} monitoring) has a cost of goods <40× lower than the purchase price of an AERONET CE318 monitor. According to certain embodiments, the cost of goods—particularly circuit boards and mechanical components—would be reduced at higher quantities. In some examples, reference-grade CE318 monitors are advantageous with respect to measurement automation (e.g. sun tracking allows for many measurements throughout the day), the number of AOD wavelengths (nine for the standard model), and the potential for additional sky radiation measurements beyond AOD.

AERONET co-location results indicate the AMOD (e.g., AMOD 102 and/or 200) can be used to measure AOD with high accuracy when measurements are initiated and overseen by an operator; however, in certain embodiments, it remains difficult to assess the reliability of unsupervised measurements taken at 24 and 48-hour intervals after the original measurement. In some examples, wind and other disturbances can cause slight misalignment to occur between the first and second measurements. Any software adjustments made to compensate for the day-to-day variation in the sun's path assume stability of the AMOD (e.g., AMOD 102 and/or 200) throughout the sampling period according to certain embodiments. In some examples, without automated self-correction or operator intervention, misalignment manifests itself with erroneously high AOD measures, which are difficult to discriminate from cloud-contaminated measurements. Manual screening requires operator attention, which cannot be expected for a 48+ hour sampling period. In certain embodiments, automated cloud screening could benefit from active solar tracking and relatively high frequency measurements.

In certain embodiments, active tracking would eliminate the need for algorithmic adjustments to account for daily solar position, enable measurement of daily AOD trends, increase solar power input, and enable robust cloud-screening algorithms. In some examples, closed-loop solar tracking will be facilitated by the solar-alignment sensor (e.g., the solar alignment sensor 122). In some examples, the sensor measures solar alignment based on differential signals between elements of a quadrant photodiode array. Sensor-geometry specific calibration factors enable accurate computation of two-dimensional incidence angles according to certain embodiments. In some examples, incidence angle information will be used in conjunction with a closed-loop motor control algorithm to locate and track the Sun.

According to certain embodiments, AMOD (e.g., AMOD 102 and/or 200) measurements are amenable to re-analysis using ozone data from outside models or retrievals. Re-analysis may be used to compensate for NO₂ absorption in the 440 nm and 520 nm channels, which is unaccounted for in standard AMOD (e.g., AMOD 102 and/or 200) measurements in certain embodiments. According to certain embodiments, improved ozone compensation calculations may be performed. For example, ozone retrievals may be leveraged across the U.S. to improve ozone compensation calculations.

### 3.2 Gravimetric PM_{2.5} Sampler Evaluation

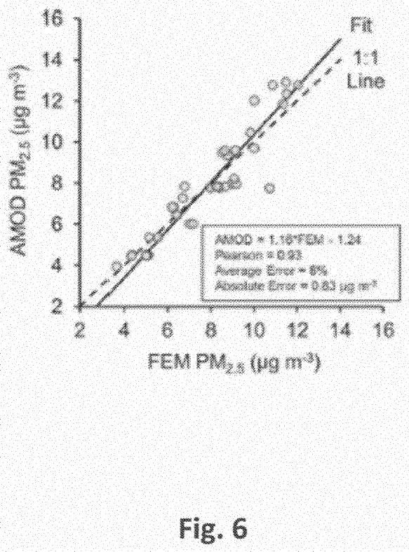

Relatively good agreement was found between AMOD (e.g., AMOD 102 and/or 200) gravimetric PM_{2.5} and FEM samplers in the co-location study (see FIG. 6). The Pearson correlation between 39 co-located AMOD (e.g., AMOD 102 and/or 200) and FEM measurements was 0.93. The mean absolute error was 0.83 μg m-3, corresponding to a mean relative error of 8% between instruments. The mean difference was −0.0037 μg m-3 with 95% confidence upper and lower limits of agreement of 1.84 and −1.85 μg m-3 respectively. A Bland-Altman plot indicated a low systematic bias between the two instruments as a function of PM_{2.5} concentration. These results were consistent with the agreement observed in previous work between PM_{2.5} mass concentrations measured using UPAS gravimetric samples and other accepted gravimetric sampling techniques. These results are encouraging given the low 48-hour average PM_{2.5} concentrations in Fort Collins during this period (ranging from 3.9 to 12.4 μg m-3).

Agreement between AMOD (e.g., AMOD 102 and/or 200) units was comparable to the agreement between AMOD (e.g., AMOD 102 and/or 200) units and FEM monitors. The average coefficient of variation between AMOD (e.g., AMOD 102 and/or 200) measurements taken concurrently with different units, expressed as a percentage, was 6.8% in certain embodiments. The relative standard deviation for AMOD (e.g., AMOD 102 and/or 200) gravimetric PM_{2.5} measurements collected using duplicate samplers at the same location was 4.9% in certain embodiments.

According to certain embodiments, the performance of the AMOD (e.g., AMOD 102 and/or 200) PM_{2.5} sampler was promising in the context of its low cost and compact, portable form factor relative to the FEM. In certain embodiments, the AMOD (e.g., AMOD 102 and/or 200) cost of goods was less than the purchase price of the FEM used in the co-location studies by a factor of 12. In some examples, the AMOD (e.g., AMOD 102 and/or 200) was 97% lighter and more compact than the FEM when both were in their stowed configuration. Size comparisons when deployed depend on the apparatus used to mount the AMOD (e.g., AMOD 102 and/or 200) (e.g., camera tripod). The embodiments have evaluated cyclone performance at concentrations exceeding 20 μg m-3 and observed similar agreement with FEM monitors. Further, the UPAS technology (the gravimetric sampling technology with which the AMOD (e.g., AMOD 102 and/or 200) was developed) has been evaluated against reference monitors by several groups at concentrations approaching 1000 μg m-3 with similar results.

### 3.3 Light-Scattering PM_{2.5} Sensor Evaluation

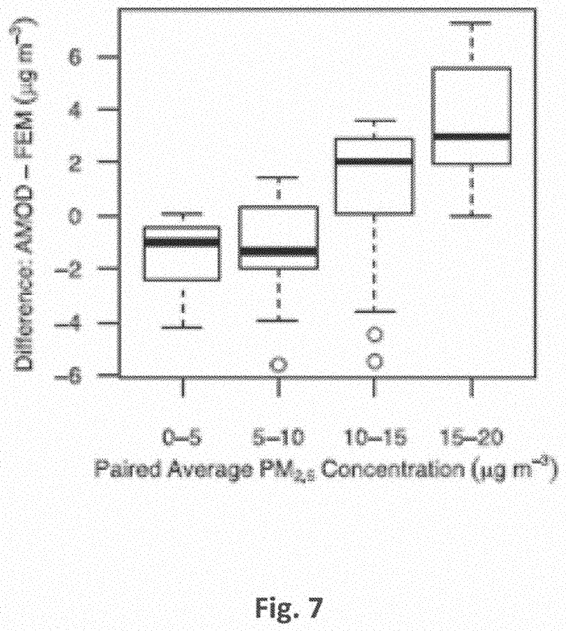

Co-location results for the AMOD (e.g., AMOD 102 and/or 200) light-scattering sensor indicated good agreement with a GRIMM FEM light-scattering sensor, albeit with an apparent directional bias in certain embodiments. A box plot of paired average vs. paired difference PM_{2.5} concentration is provided in FIG. 7. In some examples, measurement pairs consist of temporally and spatially coincident, hourly average AMOD (e.g., AMOD 102 and/or 200) and FEM PM_{2.5} measurements. Reported AMOD (e.g., AMOD 102 and/or 200) measurements are filter-corrected in certain embodiments. Concentrations reported by the FEM ranged from 0 to 17 μg m-3 in certain embodiments. After normalizing the time-resolved AMOD (e.g., AMOD 102 and/or 200) measurements to the filter, the mean absolute error was 1.98 μg m-3 in certain embodiments. In some examples, the mean difference was 0.04 μg m-3 with 95% confidence upper and lower limits of agreement of 5.02 and −4.95 μg m-3, respectively. In some examples, for pair-averaged PM_{2.5} concentrations less than 10 μg m-3, AMOD (e.g., AMOD 102 and/or 200) measurements were generally low relative to FEM measurements. For pair-averaged PM_{2.5} concentrations greater than 10 μg m-3, AMOD (e.g., AMOD 102 and/or 200) measurements were generally high relative to FEM measurements in certain embodiments. According to certain embodiments, this trend held for both corrected and uncorrected AMOD (e.g., AMOD 102 and/or 200) light-scattering sensor measurements.

According to certain embodiments, one limitation associated with the FEM and the PMS5003 is the low digital resolution. In some examples, both monitors report integer values (e.g., PMS5003 before filter normalization), which can magnify or obscure relative errors at low concentrations. Readings of 0 μg m-3 are especially problematic because they cannot be corrected to the filter via scaling factor multiplication in certain embodiments. This leaves zero readings uncorrected and tends to magnify the scaling of non-zero readings (FIG. 7).

In certain embodiments, the AMOD (e.g., AMOD 102 and/or 200) light-scattering sensor represents cost savings over reference-quality light-scattering monitors and performance improvements over other low-cost sensors. In some examples, the cost of goods of the AMOD (e.g., AMOD 102 and/or 200) is 20× less than the purchase prices of two reference quality monitors: the ThermoFisher Tapered Element Oscillating Microbalance (TEOM™) and the GRIMM monitor used in the co-location studies. Filter correction and weatherproof hardware integration may increase the accuracy and durability of the AMOD (e.g., AMOD 102 and/or 200) light-scattering measurement system compared with stand-alone low-cost sensors in certain embodiments.

### 3.4 Wireless Capability

In certain embodiments, smartphone connectivity and control is an advantage of the AMOD (e.g., AMOD 102 and/or 200). In some examples, the custom AMOD (e.g., AMOD 102 and/or 200) smartphone application serves as a wireless control platform, condensed user manual, and data transfer tool. Wireless control allows the user to start the sampler without the risk of altering an established alignment. Systematic instructions reduce the potential for operator error and omission. Wireless data transfer is less labor intensive than hardware alternatives (e.g., SD™ card) and can be directly interfaced with a web server via the smartphone Wi-Fi in certain embodiments. The present Bluetooth™ smartphone application may not be able to connect to the AMOD (e.g., AMOD 102 and/or 200) while running, may not display run data in the app, and may downloads data at slow speeds (often in excess of five minutes for a full 48.25-hr dataset) in certain embodiments. In some examples, expanding the web connectivity of the AMOD (e.g., AMOD 102 and/or 200) to include real-time data transfer and visualization using the Wi-Fi chip is the subject of ongoing work. In some examples, data transfer and real-time visualization capabilities have been developed for the AMOD (e.g., AMOD 102 and/or 200). In some examples, the data transfer is initiated by a user querying the data and/or data being pushed to a server for user feedback. In certain embodiments, the data transfer is performed using, for example, a free Internet of Things (IoT) service (e.g., ThingSpeak™) and/or a cellular connection, a WiFi connection (such as the ESP8266 Wi-Fi chip or ESP32 Wi-Fi chip), and/or a Bluetooth connection (e.g., or RN4677 Bluetooth Module). In some examples, further development could enable faster data transfer and immediate feedback for participants in AMOD (e.g., AMOD 102 and/or 200) deployments. These capabilities could bolster the scientific potential of AMOD (e.g., AMOD 102 and/or 200) data, provide an interface with other web-connected devices, and facilitate operator engagement.

### 3.5 Potential Sampler Network

The combination of AOD, gravimetric filter PM_{2.5}, and real-time PM_{2.5} sampling on a compact, user-friendly, and relatively low-cost platform, make the AMOD (e.g., AMOD 102 and/or 200) amenable to large-scale deployment in spatially dense sampling networks. Given these characteristics, the AMOD (e.g., AMOD 102 and/or 200) can deployed in large numbers, by either trained or citizen scientists, to collect spatially dense AOD and PM_{2.5} data sets. These data sets, which can be used to gain a better understanding of spatial and temporal variations in the relationship between AOD and PM_{2.5} concentration, have the potential to improve and expand the use of satellite AOD-derived estimates of ground-level PM_{2.5} concentrations. We demonstrate the potential to use the AMOD (e.g., AMOD 102 and/or 200) for a citizen science network in our companion paper (Ford et al., 2019), which describes the pilot CEAMS network in northern Colorado, the contents of which are herein incorporate for all purposes.

Some or all components of various embodiments of the present invention each are, individually and/or in combination with at least another component, implemented using one or more software components, one or more hardware components, and/or one or more combinations of software and hardware components. In another example, some or all components of various embodiments of the present invention each are, individually and/or in combination with at least another component, implemented in one or more circuits, such as one or more analog circuits and/or one or more digital circuits. In yet another example, while the embodiments described above refer to particular features, the scope of the present invention also includes embodiments having different combinations of features and embodiments that do not include all of the described features. In yet another example, various embodiments and/or examples of the present invention can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to perform the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, EEPROM, Flash memory, flat files, databases, programming data structures, programming variables, IF-THEN (or similar type) statement constructs, application programming interface, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, DVD, etc.) that contain instructions (e.g., software) for use in execution by a processor to perform the methods' operations and implement the systems described herein. The computer components, software modules, functions, data stores and data structures described herein may be connected directly or indirectly to each other in order to allow the flow of data needed for their operations. It is also noted that a module or processor includes a unit of code that performs a software operation and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

This specification contains many specifics for particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be removed from the combination, and a combination may, for example, be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof.

1. A portable atmospheric monitor configured to determine an aerosol optical depth and a particulate matter (PM) concentration, the portable atmospheric monitor comprising:
a housing at least partially enclosing an inner chamber, the housing comprising an inlet and an aperture;
at least one light sensor arranged within the housing, the at least one light sensor configured to sense one or more wavelengths of sunlight received via the aperture;
at least one light-scattering sensor arranged within the housing, the at least one light-scattering sensor configured to sense PM received via the inlet; and
a processor arranged within the housing and coupled to the at least one light sensor and the at least one light-scattering sensor, the processor configured to:
receive at least one light signal from the at least one light sensor;
receive at least one PM signal from the at least one light-scattering sensor;
determine the aerosol optical depth based upon the at least one light signal; and
determine the PM concentration based upon the at least one PM signal.

2. The portable atmospheric monitor of claim 1, wherein the light sensor is configured to sense light for four or more wavelength bandwidths.

3. The portable atmospheric monitor of claim 2, wherein a width of at least one of the four or more wavelength bandwidths is less than or equal to 15 nanometers.

4. The portable atmospheric monitor of claim 2, wherein the four or more wavelength bandwidths are centered on one or more of the following wavelengths: 340 nanometers (nm), 380 nm, 440 nm, 500 nm, 675 nm, 870 nm, 1020 nm, and 1640 nm.

5. The portable atmospheric monitor of claim 1, wherein the at least one light-scattering sensor is configured to sense PM_{2.5}.

6. The portable atmospheric monitor of claim 1, wherein the at least one light-scattering sensor comprises more than one light-scattering sensor.

7. The portable atmospheric monitor of claim 6, wherein a first light-scattering sensor of the at least one light scattering sensor is configured to sense PM_{2.5} and a second light-scattering sensor of the at least one light scattering sensor is configured to sense PM₁₀.

8. The portable atmospheric monitor of claim 1, wherein the processor is further configured to:
identify obstructing objects between the sun and the at least one light sensor; and
remove received sensor measurements obtained by the at least one light sensor when the obstructing objects are between the sun and the at least one light sensor.

9. The portable atmospheric monitor of claim 8, wherein the processor is configured to identify obstructing objects using machine learning.

10. The portable atmospheric monitor of claim 1, wherein the at least one light sensor is a photodiode.

11. A method for determining an aerosol optical depth and a particulate matter (PM) concentration using the same device, the method comprising:
receiving at least one light signal from at least one light sensor arranged within a housing of a portable atmospheric monitor;
receiving at least one PM signal from at least one light-scattering sensor, wherein the at least one light-scattering sensor is arranged within the housing of the portable atmospheric monitor;
determining the aerosol optical depth based upon the at least one light signal; and
determining the PM concentration based upon the at least one PM signal.

12. The method of claim 11, wherein receiving at least one light signal comprises receiving light for four or more wavelength bandwidths.

13. The method of claim 12, wherein a width of at least one of the four or more wavelength bandwidths is less than or equal to 15 nanometers.

14. The method of claim 12, wherein the four or more wavelength bandwidths are centered on one or more of the following wavelengths: 340 nanometers (nm), 380 nm, 440 nm, 500 nm, 675 nm, 870 nm, 1020 nm, and 1640 nm.

15. The method of claim 11, wherein the at least one PM signal corresponds to PM_{2.5}, wherein a first light-scattering sensor of the at least one light scattering sensor senses PM_{2.5} and a second light-scattering sensor of the at least one light scattering sensor senses PM₁₀.

16. The method of claim 11, further comprising:
identifying obstructing objects between the sun and the at least one light sensor, wherein machine learning is used to identify obstructing objects; and
removing received sensor measurements obtained by the at least one light sensor when the obstructing objects are between the sun and the at least one light sensor.
